(19) United States
(12) Patent Application Publication
(10) Pub. No.: US 2025/0074179 A1
(43) Pub. Date: Mar. 6, 2025

(54) LOCK RELEASING METHOD

(71) Applicant: ISUZU MOTORS LIMITED, Yokohama-shi (JP)

(72) Inventors: Muneyuki OSAWA, Fujisawa-shi (JP); Yuuki TENMA, Fujisawa-shi (JP); Hijiri FUKAYA, Fujisawa-shi (JP)

(21) Appl. No.: 18/820,356

(22) Filed: Aug. 30, 2024

(30) Foreign Application Priority Data
Sep. 4, 2023 (JP) 2023-142868

(51) Int. Cl. B60K 1/04; E05B 77/00

(52) U.S. Cl. CPC B60K 1/04; E05B 77/00

(57) ABSTRACT

Provided is a lock releasing method including: moving an arm part of a replacement apparatus in a horizontal direction such that a leading-end part of the arm part is located in a position downward from a mounting position of a battery, where the mounting position is a position in which the battery is mounted in a vehicle; moving the leading-end part upward such that the battery is placed on the leading-end part; and releasing a lock of the battery in the vehicle after the battery is placed on the leading-end part.

### TECHNICAL FIELD

The present disclosure relates to a lock releasing method.

### BACKGROUND ART

Conventionally, in a vehicle including a battery, such as an electric vehicle and a hybrid vehicle, the battery is locked in the vehicle body on the inner side of the vehicle. For example, Patent Literature (hereinafter referred to as “PTL”) 1 discloses a replacement apparatus capable of attaching and detaching a battery case drawn out via a rail member (sliding part) provided in a vehicle.

### CITATION LIST

### Patent Literature

### PTL 1

Japanese Patent Publication Laid-Open No. 2015-174476

### SUMMARY OF INVENTION

### Technical Problem

Nonetheless, when the lock of the battery in the vehicle body is released for replacing the battery, the battery may move from its mounting position, in which the battery is mounted in the vehicle body, at an unintended timing for a worker due to the inclined state of the vehicle when the vehicle stops, or the like. In addition, when a lock mechanism separate from the lock mechanism on the side of the vehicle body is provided so as to prevent the battery from moving, the time for replacement and/or cost may increase since the mechanism as a whole becomes complicated, such as there is a need to provide a mechanism or the like for releasing the separate lock mechanism.

An object of the present disclosure is to provide a lock releasing method capable of suppressing the movement of a battery at an unintended timing for a worker when a lock is released.

### Solution to Problem

A lock releasing method according to the present disclosure is a lock releasing method of releasing, by a replacement apparatus which includes a main body part and an arm part that is movably supported by the main body part, a lock of a battery. The lock releasing method includes: moving the arm part in a horizontal direction such that a leading-end part of the arm part is located in a position downward from a mounting position of the battery, where the mounting position is a position in which the battery is mounted in a vehicle; moving the leading-end part upward such that the battery is placed on the leading-end part; and releasing the lock of the battery in the vehicle after the battery is placed on the leading-end part.

### Advantageous Effects of Invention

According to the present disclosure, it is possible to suppress the movement of a battery at an unintended timing for a worker when a lock is released.

### BRIEF DESCRIPTION OF DRAWINGS

FIG. 1 illustrates a vehicle including an attachment apparatus to which a replacement apparatus capable of executing a lock releasing method according to an embodiment of the present disclosure is applied;

FIG. 2 is a diagram in which the attachment apparatus is viewed in the X direction;

FIG. 3A is a diagram provided for describing the movement of a battery via a sliding part;

FIG. 3B is a diagram provided for describing the movement of the battery via the sliding part;

FIG. 4A illustrates the configuration of the replacement apparatus;

FIG. 4B illustrates the configuration of the replacement apparatus;

FIG. 5 is a flowchart illustrating an exemplary flow of processing executed by each apparatus in the present embodiment;

FIG. 6 is a diagram provided for describing detachment of the battery by the replacement apparatus;

FIG. 7 is a diagram provided for describing the detachment of the battery by the replacement apparatus;

FIG. 8 is a diagram provided for describing the detachment of the battery by the replacement apparatus;

FIG. 9 is a diagram provided for describing the detachment of the battery by the replacement apparatus; and

FIG. 10 is a diagram provided for describing the detachment of the battery by the replacement apparatus.

### DESCRIPTION OF EMBODIMENTS

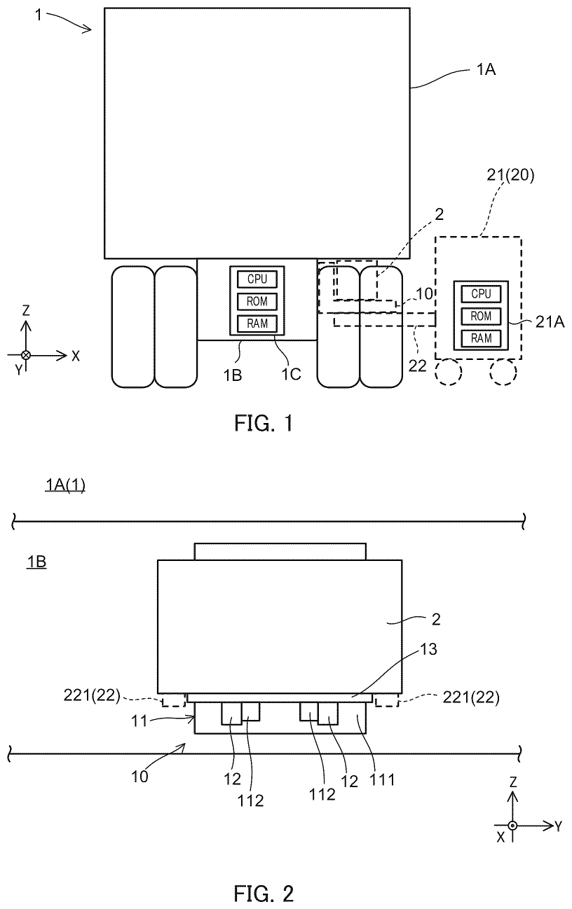

Hereinafter, an embodiment of the present disclosure will be described in detail with reference to the accompanying drawings. FIG. 1 illustrates a vehicle including an attachment apparatus to which a replacement apparatus capable of executing a lock releasing method according to the embodiment of the present disclosure is applied.

In the description of the structure of the replacement apparatus, an orthogonal coordinate system (X, Y, Z) is used. The drawings to be described later are also illustrated with a common orthogonal coordinate system (X, Y, Z). The X direction indicates the left-right direction of vehicle 1 in which the replacement apparatus is mounted, the Y direction indicates the front-rear direction of vehicle 1, and the Z direction indicates the up-down direction of vehicle 1.

As illustrated in FIG. 1, vehicle 1 is a vehicle capable of traveling with battery 2, such as an electric vehicle and a hybrid vehicle. In addition, vehicle 1 is a large vehicle such as a truck, and load bed 1A is mounted therein. In addition, vehicle body 1B of vehicle 1, in which load bed 1A is mounted, is provided with attachment apparatus 10 for attaching battery 2.

Battery 2 is locked, in a mounting position on the inner side of vehicle 1, in vehicle body 1B by attachment apparatus 10. When battery 2 is replaced, replacement apparatus 20 is used.

In addition, vehicle 1 is provided with control part 1C. Control part 1C includes a central processing unit (CPU), a read only memory (ROM), a random access memory (RAM), and an input-output circuit (not illustrated), and performs, for example, control related to vehicle 1. In addition, control part 1C is communicable with an external apparatus (for example, replacement apparatus 20), and may perform control for locking/lock releasing of battery 2 in/from vehicle body 1B based on an instruction of the external apparatus, for example.

In the following description, the configuration of attachment apparatus 10 to which replacement apparatus 20 is applied will be first described before replacement apparatus 20 according to the present embodiment is described in detail.

As illustrated in FIG. 2, attachment apparatus 10 includes main body part 11, sliding part 12, and placement part 13.

Main body part 11 is disposed in a position corresponding to a lower portion (on the −side in the Z direction) of load bed 1A, and includes wall part 111 and support part 112.

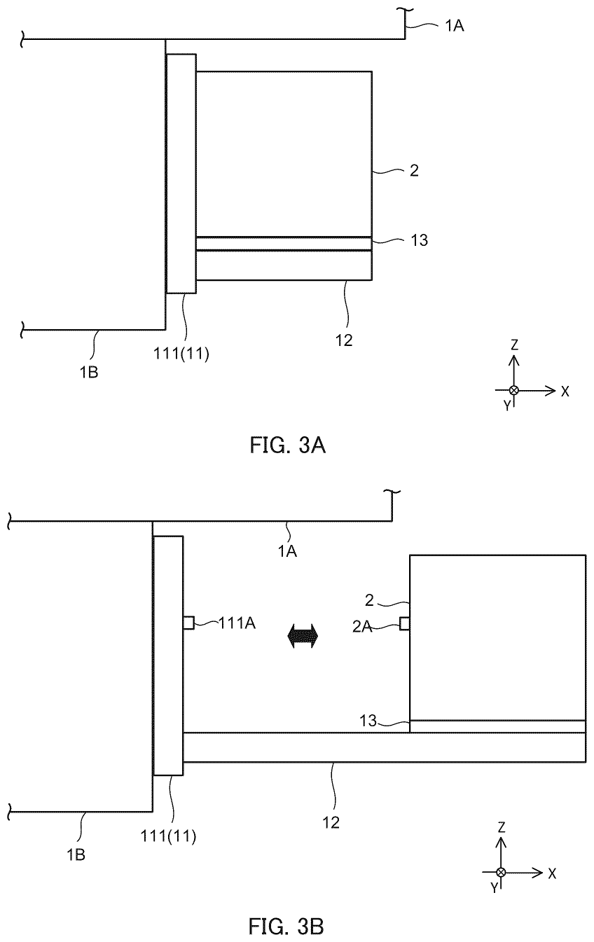

Wall part 111 is a wall disposed along the Z direction, and is fixed to, for example, a side surface (on the +side in the X direction) of vehicle body 1B. Wall part 111 is provided with latch 111A that engages with striker 2A provided on a side surface of battery 2 (see FIG. 3B). Battery 2 is locked in vehicle 1 by latch 111A engaging with striker 2A.

Note that, locking and lock releasing at latch 111A and striker 2A are switching-controlled by control part 1C on the side of vehicle 1.

Support part 112 is a member extending from the end part of wall part 111 on the −side in the Z direction toward the +side in the X direction, and two support parts 112 are provided side by side in the Y direction. Support part 112 is disposed such that when battery 2 is fixed to vehicle 1, support part 112 supports placement part 13 and battery 2 from the −side in the Z direction.

Sliding part 12 is a telescopic sliding rail for moving battery 2 between the inner side and the outer side of vehicle 1. Sliding part 12 is fixed to support part 112, for example.

As illustrated in FIG. 3A, in a case where sliding part 12 is in the most contracted state, sliding part 12 is located in a range on the inner side of vehicle 1 in the X direction. The position in the range on the inner side of vehicle 1 described above is, for example, a position downward from load bed 1A, and may be the mounting position of battery 2 (placement part 13), in which battery 2 is mounted in vehicle body 1B.

As illustrated in FIG. 3B, in a case where sliding part 12 is in the most extended state, a leading-end part of sliding part 12 is located on the +side of load bed 1A in the X direction, that is, in a range on the outer side of vehicle 1. The position in the range on the outer side of vehicle 1 described above may be a position which is on the outer side of vehicle 1 in the X direction and in which battery 2 is attachable and detachable to and from placement part 13, and may be, for example, the position of battery 2 (placement part 13) when sliding part 12 is in the most extended state.

Placement part 13 is a portion on which battery 2 is placed, and is attached to sliding part 12. In addition, the surface of placement part 13 on the +side in the Z direction and the bottom surface of battery 2 may be provided with a lock mechanism for locking battery 2 in placement part 13.

In addition, as illustrated in FIG. 2, the width of placement part 13 in the Y direction is narrower than the width of battery 2 in the Y direction. For this reason, it is configured such that when battery 2 is placed on a pair of arms 221, which will be described later, of replacement apparatus 20, placement part 13 is located between two arms 221.

Next, details of replacement apparatus 20 will be described.

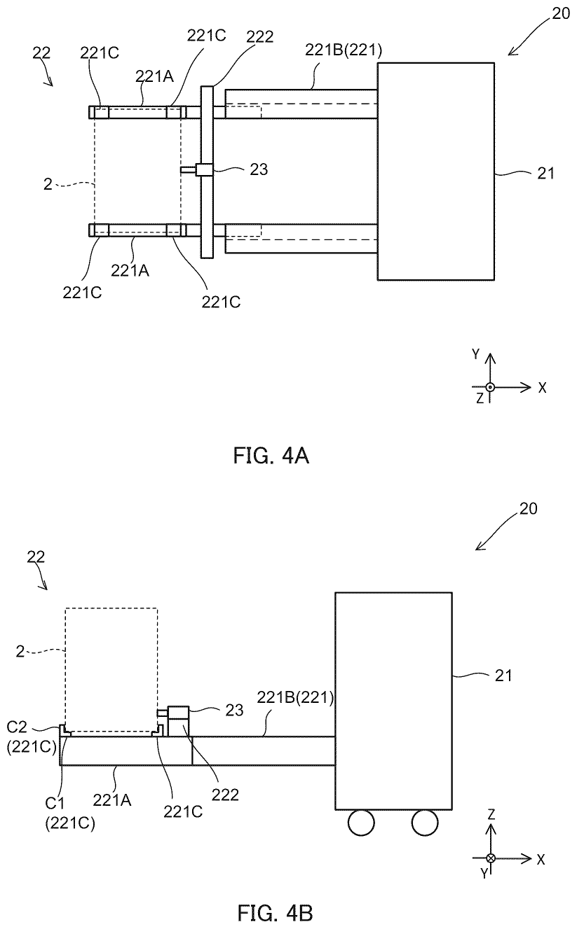

As illustrated in FIG. 1, replacement apparatus 20 is an apparatus capable of conveying battery 2 on attachment apparatus 10 inward and outward for replacing battery 2. Replacement apparatus 20 includes main body part 21, arm part 22, and battery detection sensor 23 (see FIG. 4A or the like). Note that, the directions of each part in the following description use, as a reference, replacement apparatus 20 disposed to face the side surface of vehicle 1 on the +side in the X direction.

Main body part 21 is a main body portion of replacement apparatus 20, and movably supports arm part 22 in the Z direction. For example, main body part 21 is provided with control part 21A. Control part 21A includes a CPU, a ROM, a RAM, and an input-output circuit (not illustrated), and controls the movement of arm part 22. Note that, control part 21A may be provided outside main body part 21 to control the movement of arm part 22 by remote control.

As illustrated in FIGS. 4A and 4B, arm part 22 is configured such that battery 2 can be placed thereon. Arm part 22 includes the pair of arms 221 and bridge part 222.

The pair of arms 221 is supported by main body part 21 so as to movable in the Z direction, and extends in the X direction. Arm 221 includes leading-end part 221A and support part 221B.

Leading-end part 221A is a portion on which battery 2 is placed, and is supported by support part 221B. Support part 221B is a portion supported by main body part 21. Support part 221B is configured in a rail shape extending in the X direction, and movably supports leading-end part 221A in the X direction.

Leading-end parts 221A of the pair of arms 221 are provided with holding parts 221C for holding battery 2. A total of four holding parts 221C are provided, with two holding parts 221C for each arm 221. Four holding parts 221C are located, for example, in positions corresponding to corner parts of battery 2 having a rectangular parallelepiped shape, respectively.

As illustrated in FIG. 4B, holding part 221C includes first part C1 and second part C2. First part C1 is a portion that is fixed to the surface of leading-end part 221A on the +side in the Z direction. Second part C2 is a portion that extends from first part CI to the +side in the Z direction and is along a side surface of battery 2 which is held. Second parts C2 of four holding parts 221C are located so as to surround battery 2, and thus, holding parts 221C hold battery 2.

Bridge part 222 is a portion that bridges leading-end parts 221A of the pair of arms 221, and is provided, in leading-end parts 221A, on the +side of holding parts 221C in the X direction. A center portion of bridge part 222 is provided with battery detection sensor 23.

Battery detection sensor 23 is a sensor for detecting battery 2, and may be, for example, a contact-type sensor known in the art.

In addition, the positions corresponding to the initial positions of the pair of arms 221 are, in the Z direction, on the −side of battery 2 locked in vehicle 1. In addition, in a case where the positions of arms 221 are the initial positions thereof, the height of battery detection sensor 23 corresponds to, in the Z direction, the height of battery 2 locked in vehicle 1.

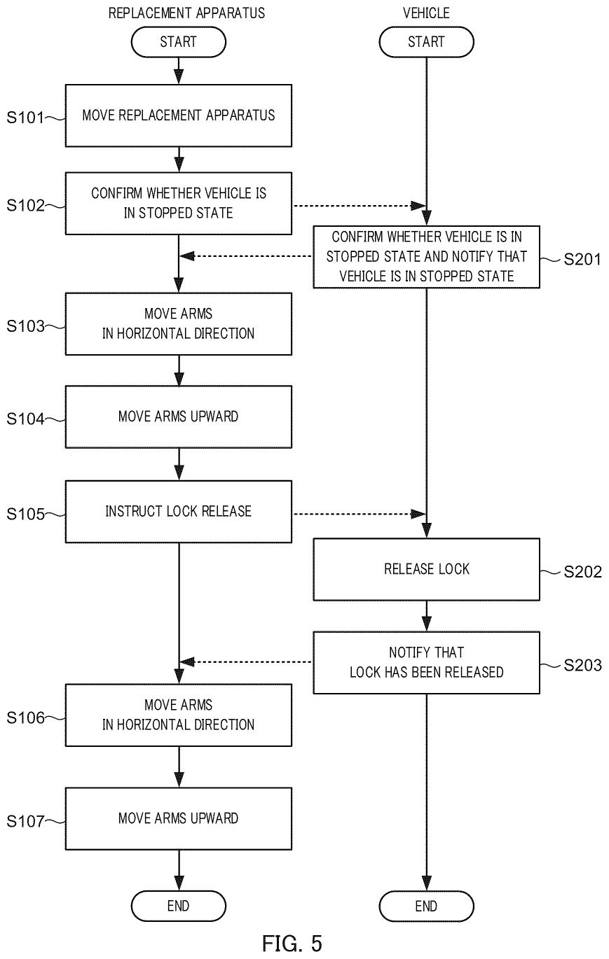

Next, operations of replacement apparatus 20 will be described. FIG. 5 is a flowchart illustrating an exemplary flow of processing executed by each apparatus in the present embodiment. Starting from the left side, exemplary processing executed by control part 21A of replacement apparatus 20 and exemplary processing executed by control part 1C of vehicle 1 are illustrated, respectively. Note that, the flowchart in FIG. 5 assumes that there is vehicle 1 which enters an area, where replacement apparatus 20 is movable, and is in a stopped state. The area where replacement apparatus 20 is movable is, for example, an area where replacement apparatus 20 is managed, and may be, for example, a location, such as a replacement station, at which battery 2 in the fully charged state is stored.

As illustrated in FIG. 5, control part 21A of replacement apparatus 20 causes replacement apparatus 20 to move such that replacement apparatus 20 is disposed in a position on a lateral side of vehicle 1, in which replacement apparatus 20 faces battery 2 (step S101).

Specifically, control part 21A of replacement apparatus 20 may search for vehicle 1 with a vehicle detection sensor (not illustrated) provided in replacement apparatus 20, and may control the movement of replacement apparatus 20 based on detection information of the vehicle detection sensor. In addition, control part 21A of replacement apparatus 20 may communicate with control part 1C of vehicle 1 or an external apparatus to acquire position information on vehicle 1, and may control the movement of replacement apparatus 20 based on the position information.

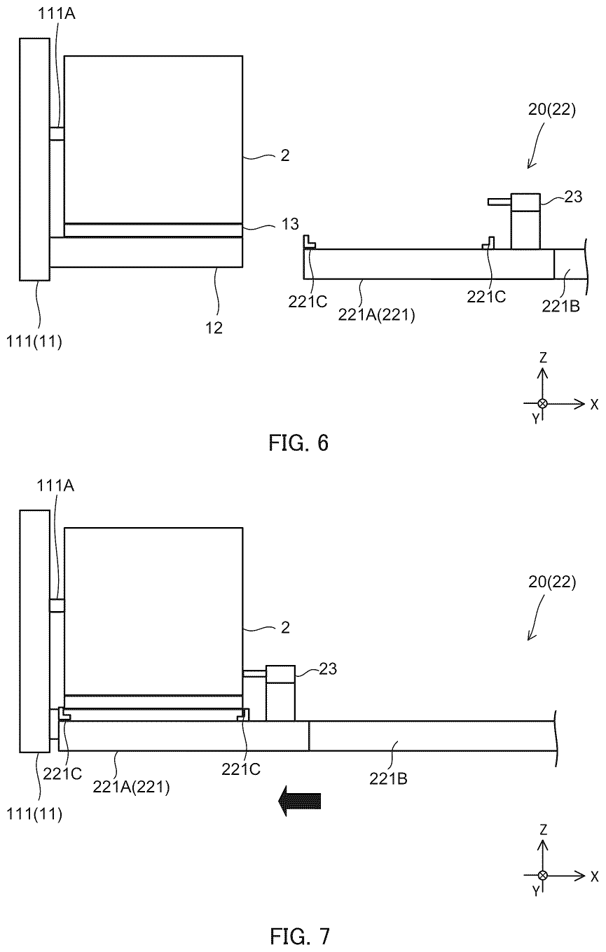

In step S101, replacement apparatus 20 is disposed in a position in which replacement apparatus 20 faces battery 2 in vehicle 1 as illustrated in FIG. 6.

Next, control part 21A of replacement apparatus 20 confirms with the side of vehicle 1 whether vehicle 1 is in the stopped state (step S102). Specifically, control part 21A of replacement apparatus 20 transmits an instruction to cause vehicle 1 to be in the stopped state, such as an instruction to cause the gear to be in the parking position and an instruction to turn the key off (an instruction to cause the relay of battery 2 to be in the open state), to control part 1C of vehicle 1.

After step S102, control part 1C of vehicle 1 confirms whether vehicle 1 is in the stopped state, and notifies the side of replacement apparatus 20 that vehicle 1 is in the stopped state (step S201).

For example, control part 1C of vehicle 1 confirms whether the gear is in the parking position and/or whether the relay of battery 2 is open. In a case where the gear is not in the parking position, control part 1C of vehicle 1, for example, may notify the driver of vehicle 1 for urging the driver to cause the gear to be in the parking position or may cause the gear to be in the parking position automatically. In addition, in a case where the relay of battery 2 is not open, control part 1C of vehicle 1, for example, may notify the driver of vehicle 1 for urging the driver to turn the key off or may cause the key to be turned off automatically.

After confirming that vehicle 1 is in the stopped state, control part 1C of vehicle 1 notifies the side of replacement apparatus 20 that vehicle 1 is in the stopped state.

After step S201, control part 21A of replacement apparatus 20 causes arms 221 to move in the horizontal direction (to the −side in the X direction) (step S103). Specifically, control part 21A of replacement apparatus 20 causes arms 221 to move by causing main body part 21 to move to the −side in the X direction as illustrated in FIG. 7. Then, when battery detection sensor 23 detects battery 2, control part 21A of replacement apparatus 20 causes main body part 21 to stop moving. Thus, leading-end parts 221A of arms 221 are located in positions downward from the mounting position of battery 2, in which battery 2 is mounted in vehicle 1.

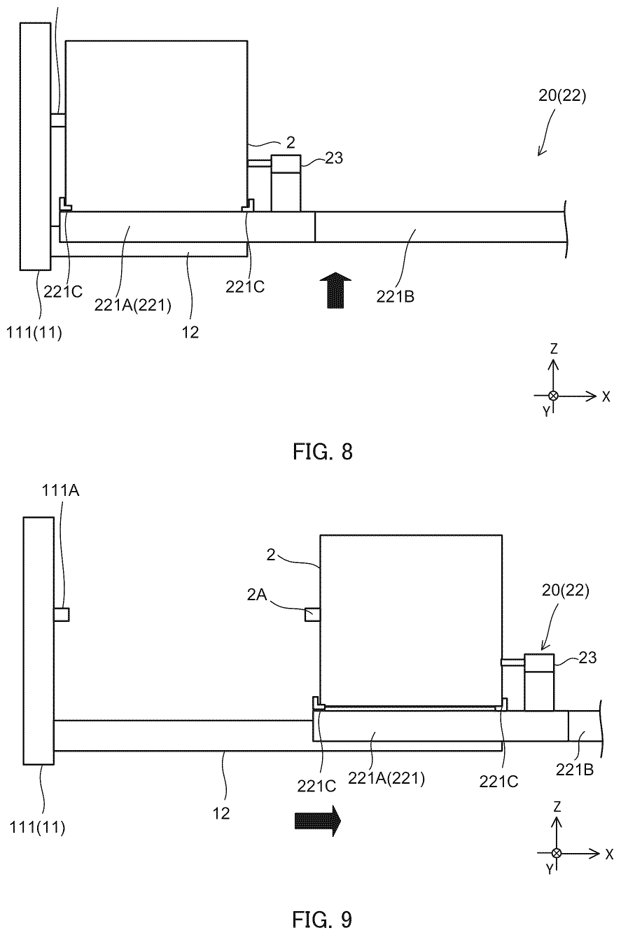

After step S103, control part 21A of replacement apparatus 20 causes arms 221 to move to the +side in the Z direction (upward) (step S104). Specifically, control part 21A of replacement apparatus 20 causes arms 221 to rise to the height of battery 2 as illustrated in FIG. 8. Thus, battery 2 is placed on leading-end parts 221A of arms 221, that is, is held by holding parts 221C. Note that, the placement of battery 2 on leading-end parts 221A in this case may be in a state in which the total load of battery 2 is applied to leading-end parts 221A, or in a state in which leading-end parts 221A are in contact with the bottom surface of battery 2, but the load of battery 2 is not applied to leading-end parts 221A. In addition, in the case of a state in which the position of battery 2 on leading-end parts 221A after lock releasing is surely determined (for example, a state in which battery 2 is surely located in a range of holding parts 221C, or the like), a state in which leading-end parts 221A are not in contact with battery 2 may be included in the state of the placement of battery 2 on leading-end parts 221A.

After step S104, control part 21A of replacement apparatus 20 instructs the side of vehicle 1 to release the lock of battery 2 after battery 2 is held by holding parts 221C (step S105). After step S105, control part 1C of vehicle 1 causes the lock of battery 2 in vehicle 1 to be released (step S202).

After step S202, control part 1C of vehicle 1 notifies the side of replacement apparatus 20 that the lock of battery 2 has been released (step S203).

After step S203, control part 21A of replacement apparatus 20 causes main body part 21 to move to the +side in the X direction (step S106). Thus, battery 2 is drawn out via sliding part 12 as illustrated in FIG. 9.

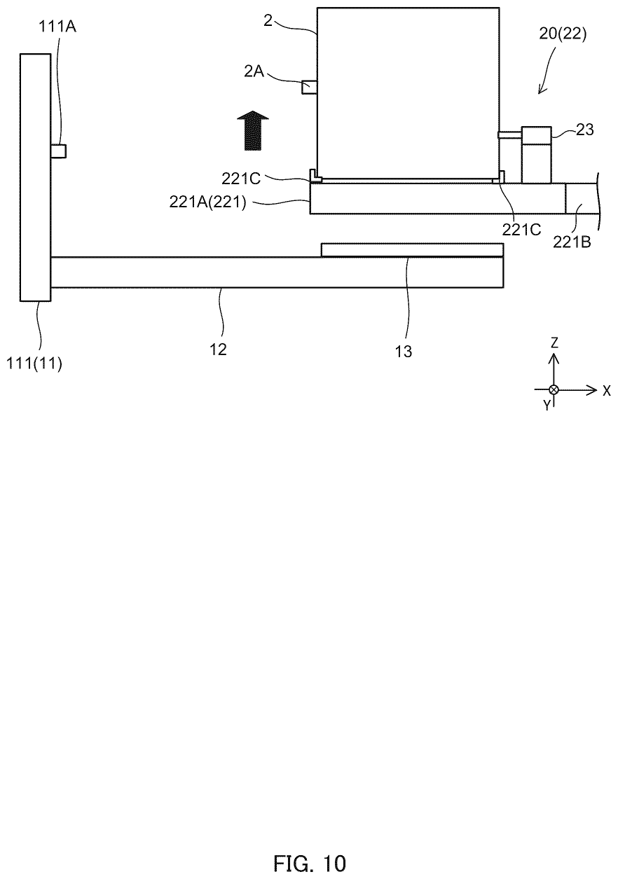

After step S106, control part 21A of replacement apparatus 20 causes arms 221 to move further to the +side in the Z direction (step S107). Thus, battery 2 is lifted from placement part 13 and is detached from attachment apparatus 10 as illustrated in FIG. 10. After step S107, this control ends.

In addition, this control is followed by attachment control that is performed by replacement apparatus 20 in which battery 2 in the fully charged state is placed on arms 221. Specifically, battery 2 is placed on placement part 13 by disposing replacement apparatus 20 in a position on a lateral side of vehicle 1, in which replacement apparatus 20 faces battery 2, and moving arms 221 to the −side in the Z direction. Then, main body part 21 moves to the −side in the X direction, thereby pushing battery 2 back to the mounting position via sliding part 12.

When battery 2 has moved to the mounting position, control part 21A of replacement apparatus 20 instructs control part 1C of vehicle 1 to cause battery 2 to be locked. When battery 2 has been locked, control part 1C of vehicle 1 notifies the side of replacement apparatus 20 of a lock completion notification. In addition, in a case where battery 2 is configured to be locked in the mounting position by an external force, battery 2 may be locked in vehicle 1 by arms 221 of replacement apparatus 20 pushing battery 2 toward the mounting position.

Thereafter, replacement apparatus 20 moves in a direction away from vehicle 1 after moving arms 221 to the −side in the Z direction to return arms 221 to their initial positions. Thus, the replacement of battery 2 is completed.

According to the present embodiment configured as described above, arms 221 are moved in the horizontal direction such that leading-end parts 221A of arms 221 are located in positions downward from the mounting position of battery 2, then leading-end parts 221A are moved upward such that battery 2 is placed on leading-end parts 221A, and thereafter the lock of battery 2 in vehicle 1 is released.

For this reason, when the lock of battery 2 is released, battery 2 is in a state of being placed on arms 221 of replacement apparatus 20. That is, battery 2 is caused to be conveyable before the lock of battery 2 is released, and then the lock of battery 2 is released.

For example, when the lock of battery 2 is released in a state in which there is no apparatus such as replacement apparatus 20, battery 2 may move from its mounting position, in which battery 2 is mounted in in vehicle body 1B, at an unintended timing for a worker due to the inclined state of vehicle 1 when vehicle 1 stops, or the like. In particular, when it is configured such that battery 2 is drawn out by using sliding part 12 as in vehicle 1 including load bed 1A, sliding part 12 is also drawn out together with battery 2 due to the inclined state of vehicle 1 when vehicle 1 stops, or the like, and thus, attachment apparatus 10 such as sliding part 12 may be damaged.

In the present embodiment, on the other hand, it is possible to suppress the movement of battery 2 at an unintended timing for a worker when the lock is released. As a result, battery 2 can be safely replaced.

In addition, a lock mechanism separate from the lock mechanism of vehicle body 1B may be provided so as to prevent battery 2 from moving in a state in which there is no apparatus such as replacement apparatus 20. The separate lock mechanism may be, for example, a lock mechanism that cannot be released on the side of vehicle 1, and that can be released by an operation or the like of a worker. In this case, the time for replacement and/or cost may increase since the mechanism as a whole becomes complicated, such as there is a need to provide a mechanism or the like for releasing the separate lock mechanism.

In the present embodiment, on the other hand, it is possible to replace battery 2 safely without providing a separate lock mechanism as described above, and thus, it is possible to simplify the mechanism as a whole, and further it is possible to contribute to a shortened time for replacement and/or a cost reduction.

In addition, when arms 221 are moved in the horizontal direction, battery 2 is detected with battery detection sensor 23 provided in arm part 22, and thus, it is possible to easily align the position of leading-end parts 221A of arms 221 in the horizontal direction with the position corresponding to battery 2.

In addition, before arms 221 are moved, it is confirmed with the side of vehicle 1 whether vehicle 1 is in the stopped state, and the side of replacement apparatus 20 is then notified that vehicle 1 is in the stopped state, and thus, the movement of arms 221 is started given the fact that vehicle 1 is in the stopped state. For this reason, since vehicle 1 does not start moving while arms 221 are moving, it is possible to prevent vehicle 1 from colliding with arms 221.

In addition, since the side of replacement apparatus 20 is notified of a completion notification, which indicates that the lock of battery 2 has been released, after the lock is released, replacement apparatus 20 can collect battery 2 upon recognition of the fact that the lock has been released.

In addition, since leading-end parts 221A of arms 221 include holding parts 221C capable of holding battery 2, replacement apparatus 20 can convey battery 2 in a state in which battery 2 is held. As a result, battery 2 can be stably conveyed by replacement apparatus 20.

Note that, in the embodiment described above, replacement apparatus 20 moves to a lateral side of vehicle 1 automatically, but the present disclosure is not limited thereto, and a worker may dispose replacement apparatus 20 on a lateral side of vehicle 1.

In addition, in the embodiment described above, the movement of the arms of the replacement apparatus is performed automatically (for example, steps S103 and S104 in FIG. 5, or the like), but the present disclosure is not limited thereto, and a worker may move the arms of the replacement apparatus.

In addition, in the embodiment described above, the control part of the replacement apparatus confirms whether the vehicle is in the stopped state, but the present disclosure is not limited thereto. For example, in a case where a worker or the control part of the replacement apparatus recognizes in advance that the vehicle has been caused to be in the stopped state, and the replacement of the battery is then started by using the replacement apparatus, the replacement apparatus may not confirm that the vehicle is in the stopped state. Further, in this case, the control part of the vehicle may not notify the side of the replacement apparatus that the vehicle is in the stopped state.

In addition, in the embodiment described above, the control part of the vehicle notifies the side of the replacement apparatus of a completion notification indicating that the lock of the battery has been released, but the present disclosure is not limited thereto, and the control part of the vehicle may not notify the side of the replacement apparatus of the completion notification.

In addition, in the embodiment described above, the arms of the replacement apparatus include the holding parts, but the present disclosure is not limited thereto, and the arms of the replacement apparatus may not include the holding parts.

In addition, although in the embodiment described above, the replacement apparatus includes the battery detection sensor, but the present disclosure is not limited thereto, and the replacement apparatus may not include the battery detection sensor.

In addition, in the embodiment described above, the arm part is configured to include the pair of arms, but the present disclosure is not limited thereto, and the arm part may have any shape as long as the battery can be placed thereon.

In addition, in the embodiment described above, the attachment apparatus of the vehicle is provided with the sliding part, but the present disclosure is not limited thereto, and the attachment apparatus of the vehicle may not be provided with the sliding part.

In addition, any of the embodiment described above is only illustration of an exemplary embodiment for implementing the present disclosure, and the technical scope of the present disclosure shall not be construed limitedly thereby. That is, the present disclosure can be implemented in various forms without departing from the gist or the main features thereof.

This application is entitled to and claims the benefit of Japanese Patent Application No. 2023-142868, filed on Sep. 4, 2023, the disclosure of which including the specification, drawings and abstract is incorporated herein by reference in its entirety.

### INDUSTRIAL APPLICABILITY

The replacement apparatus of the present disclosure is useful as a lock releasing method capable of suppressing the movement of a battery at an unintended timing for a worker when a lock is released.

1. A lock releasing method of releasing, by a replacement apparatus, a lock of a battery, the replacement apparatus including a main body part and an arm part, the arm part being movably supported by the main body part, the lock releasing method comprising:
moving the arm part in a horizontal direction such that a leading-end part of the arm part is located in a position downward from a mounting position of the battery, the mounting position being a position in which the battery is mounted in a vehicle;
moving the leading-end part upward such that the battery is placed on the leading-end part; and
releasing the lock of the battery in the vehicle after the battery is placed on the leading-end part.

2. The lock releasing method according to claim 1, wherein the moving of the arm part in the horizontal direction includes detecting the battery with a battery detection sensor provided in the arm part.

3. The lock releasing method according to claim 1, wherein the moving of the arm part in the horizontal direction includes:
confirming with a side of the vehicle, before the arm part is moved, whether the vehicle is in a stopped state; and
notifying, after the confirming, a side of the replacement apparatus that the vehicle is in the stopped state.

4. The lock releasing method according to claim 1, wherein the releasing of the lock includes notifying a side of the replacement apparatus of a completion notification after the lock is released, the completion notification indicating that the lock of the battery has been released.

5. The lock releasing method according to claim 1, wherein:
the leading-end part includes a holding part capable of holding the battery, and
the moving of the leading-end part upward includes holding, by the holding part, the battery.

6. The lock releasing method according to claim 1, wherein the vehicle includes:
a lock mechanism capable of locking the battery on a side surface of a vehicle body of the vehicle;
a sliding part that extends in the horizontal direction from a position in the vehicle body and movably supports the battery in the horizontal direction, the position corresponding to the lock mechanism; and
an installation part provided upward from a mounting portion of the battery, the mounting portion being a portion in which the battery is mounted in the vehicle body.
